(19) United States
(12) Patent Application Publication
(10) Pub. No.: US 2002/0101632 A1
(43) Pub. Date: Aug. 1, 2002

(54) Wireless laser beam communications system for stationary and mobile users

(76) Inventor: Milton Meckler, Los Angeles, CA (US)

Correspondence Address: Gregor N. Neff, Esq., c/o Kramer Levin Naftalis &, Frankel LLP, 919 Third Avenue, New York, NY, 10022, US

(21) Appl. No.: 10/061,041

(22) Filed: Jan. 30, 2002

Related U.S. Application Data
(60) Provisional application No. 60/264,960, filed on Jan. 30, 2001.
(60) Provisional application No. 60/276,226, filed on Mar. 15, 2001.

(51) Int. Cl. H04B 10/30

(52) U.S. Cl. 359/115; 375/377; 455/500

(57) ABSTRACT

A communications system comprising receiving and transmitting means for receiving and transmitting wireless optical signals wherein said receiving and transmitting means utilize holographic multiplexer, demultiplexer and storage technology for improved broadband where required while accommodating alternative communication modalities and protocols for maximum user benefit at lower cost.

This application claims the benefit of U.S. Provisional Application No. 60/264,960, filed Jan. 30, 2001, entitled “Wireless laser beaming (WLB) for stationary and mobile users” and U.S. Provisional Application No. 60/276,226, filed Mar. 15, 2001, entitled “Wireless laser beaming (SPPA) for station and mobile users”, which are both incorporated herein by reference.

### BACKGROUND OF THE INVENTION

Multiplexing is the simultaneous transmission of multiple signals through the same transmission medium. Two principal multiplexing options currently used in fiber optic systems follow; namely time-division multiplexing (TDM), which combines several digital signals in a higher speed bit stream, with slots for bits from each signal, and wavelength-division multiplexing (WDM), or dense wavelength division multiplexing (DWDM), which involves simultaneous transmission of signals of two or more different wavelengths through the same fiber or in space under a wireless modality. The signal wavelengths are combined in an optical device called a multiplexer, which delivers them to the transmitting fiber. In some cases it may be possible to merely mix the signals together, but typically multiplexers have wavelength-selective optics to isolate input signals from each other.

Signals leaving the fiber shall be separated because standard detectors may not be able to tell the wavelengths apart. An optical demultiplexer does this job, using wavelength-selective optics to direct each wavelength to a separate receiver. The wavelength channels can be separated almost completely to limit crosstalk. The optical requirements are often stringent.

Early WDM systems operated with quite broad channel spacing. Some of the early WDM applications employed had wavelengths separated so widely that they were in two different transmissions windows, e.g., at 850 and 1300 nm or at 1300 and 1550 nm. The number of channels soon multiplied and closer wavelengths were required.

WDM utilizes optical signals passing through the same fiber but at different frequencies. Similarly, WDM and DWDM wireless laser beaming (WLB) should also be separately detectable at the receiver (or rectenna) employing a demultiplexer, to deliver them to the transmitting fiber, etc. In some cases it may be possible merely to mix the signals together, but typically, multiplexers have wavelength-selective optics to isolate input signals from each other.

Signals leaving the wireless laser beam can also be separated because standard detectors may be unable to tell the wavelength apart. Poor separation during demultiplexing or non-linear interactions in the fiber or in a compressed wireless laser beam can contaminate one channel with signals from another one. Overlap of wavelength channels, often caused by leaving too little room between high-speed signals, can cause unacceptable crosstalk.

An ideal demultiplexer divides the input wavelengths into a series of slots, transmitting no light at longer or shorter wavelengths and all light within each narrow slot. Real demultiplexers don't work that way, and their pass-bands have steep boundaries, not vertical ones. Likewise, real WDM and DWDM sources have Gaussian peaks, not ideal spikes. Assuming that the signal source and demultiplexer have stable wavelengths, achieving stability still requires careful control of operating conditions, such as temperature, and active monitoring of performance. Recently, there have been a number of articles published in the related arts which provide helpful background:

10 Gigabit Ethernet Train is Rolling in

Optics have become increasingly important as each new generation of Ethernet pushes to transmit higher data rates across longer distances. The new 10 Gigabit Ethernet standard is all-optical, specifying transmission through hundreds of meters of high-bandwidth multimode fiber and through tens of kilometers of standard step-index singlemode fiber. Gigabit Ethernet can transmit 1 Gbit/s over high-performance four-pair Category 5 copper cable for up to about 100 meters, but 10 Gbit/s signals can travel no more than a few meters through either Category 5 cable or the coaxial cable used in the original Ethernet.

The standard for 10 Gigabit Ethernet will not be formally approved until the middle of next year, but the train has been building up steam. Members of the 10 Gigabit Ethernet Alliance demonstrated interoperability of their software at the NetWorld+Interop trade show in Atlanta, but it was eclipsed by the attacks on New York and Washington the day the show opened. Vendors already have optical modules available that transmit in standard formats, and the first complete switches are already available. Market conditions have cooled from the fevered pace of a year ago, but 10 Gigabit Ethernet still seems sure to find a variety of applications in high-speed data transmission.

Laser Focus World—December 2001 (Article No. 2; Pages 115-118)

Beam Shaping and High Brightness

The most convenient way to measure the beam quality of a laser diode array (LDA) is to characterize the beam parameter product (BPP) or Lagrange invariant, defined as Oₒ×Wₒ, where Oₒ is the divergence angle and Wₒ is the beam dimension. Thus, for an LDA with a divergence of 40 degree×10 degree (where 1 degree=0.017 rad), the BPP in the fast axis is 1-mm mrad, while that in the slow axis is 1700-mm mrad. The divergence in the fast axis can be collimated to a large extent by using cylindrical lenses. To improve the beam quality in the slow axis, microlens arrays can be used. In general, slow-axis correction is less successful—only about 50% of the initial divergence can be collimated. To avoid the overlap in the emission plane, other more complex methods of slow-axis collimation exist for LDAs with smaller pitch (the distance between the center of two adjacent emitters).

Currently, the most efficient way to significantly improve beam quality is to combine reshaping and collimation. Using special optical elements, the elongated beam from an LDA is divided into n pieces and rearranged into a more easily focused circular beam. Such beam shaping decreases the BPP by n-fold in the slow axis and increases it by the same ratio in the fast axis.

The most classical and straightforward method for LDA beam shaping uses a cylindrical lens to focus the laser beam into a fiber bundle array. The light from each discrete emitter of the LDA is converged into a circular beam. Such device have been on the market for several years. High brightness cannot be achieved with this method, however, because the laser mode of the LDA emitter does not match the mode of optical. Moreover, the brightness of the LDA is further decreased after the fiber bundle. For example, a typical 20-W array with an emitter area of 1 cm×1 pm and divergence angle of 10 degree×40 degree has a brightness of 1.6×10⁶ W/cm² str.

When coupled with a 0.6-mm fiber bundle with a numerical aperture of 0.18 to give a fiber output of 16 W, the brightness drops to only 5×10⁴ W/cm² str.

Another straightforward way to improve the beam shape of a high-power LDA is to use stacks. A stack consists of several LDA bars mounted on top of each other, separated by heat sinks. Multiple fast-axis collimation enables up to 1 kW of output from a 1.5-mm fiber without polarization or wavelength coupling, assuming a power density of 10⁴ W/cm² as specified by the high-power laser delivery systems of Rofin Sinar (Hamburg, Germany). By using stacks, the BPP in the fast axis is increased, but it is unchanged in the slow axis. Therefore, the beam shape with this method is still far from circular, and it is more suitable for cases involving more than 1 kW of power. Moreover, “dead” spaces due to the heat sinks between emitters limit brightness.

To further improve the beam quality and brightness, rather sophisticated beam-rearrangement mechanisms are normally used. Two typical examples are the step mirror approach used by the Fraunhofer Institute for Laser Technology (Aschen, Germany) and the two-reflector approach from researchers at the University of South Hampton (South Hampton, England). Both methods have been used commercially for making fiber-coupled laser-diode devices. Also, researchers at Apollo Instruments recently developed several new efficient approaches for beam shaping. With the support of the US Air Force Research Laboratory (Kirtland Air Force Base, NM), a series of fiber-coupled laser diodes was commercialized some with record brightness (see table). Apollo's F14-XXX-1 has a BPP of 11-mm mrad at 16 W with a brightness greater than 1 MW/cm² str, which was previously thought difficult to achieve. The brightness and power density shown in the table are derived from products using a single high-power laser-diode bar. As is commonly done, it is possible to further increase the overall power by a factor of two or more for the same beam quality by polarization and/or wavelength coupling of two or more high-power laser bars. The beam is delivered through a single optical fiber, creating a perfectly circular Gaussian spot. The beam quality is therefore much better than that obtained simply by beam shaping and focusing. With an appropriate focusing optical head, the beam from the fiber can be focused on the work piece or, if necessary, shrunk into a smaller beam spot with an enlarged numerical aperture. To better understand the beam-shaping process, closer examination of one of Apollo's approaches is helpful. In one configuration, two groups of prisms are used to divide and rearrange the beams from the LDA. In both of the prism groups, each prism is offset from the next prism along the hypotenuse by a certain distance. The first prism group divides the linear emission into multiple sections along the slow axis. The beams enter from the hypotenuse surfaces of the prisms, reflect twice in the prisms, and then exit from the hypotenuse surfaces with each beam offset from the other sequentially due to the prism offset. The beams then enter the second prism group, and are rearranged into an output beam by the same principle. As a result, the linear beam of the LDA can be reshaped into a beam spot with a similar BPP in both directions. For n=10, the BPP of the beam spot can be reduced by 10 times in the slow axis and increased by 10 times in the fast axis.

In the past, the applications of high-power laser diodes have been limited to those that do not require extremely accurate focusing of light at high-power densities, such as in plastics welding. With the availability of high-brightness devices, much wider applications are anticipated. At power densities above 10⁶ W/cm², metal marking or drilling becomes possible with direct use of high-power laser diodes.

### REFERENCES

1. Industrial Laser Solutions, January 2000 p.6

2. J. R. Hobbs, Laser Focus World, May 1994, p. 46.

3. B. R. Marx, Laser Focus World, May 1998, p. 32

Photonics—December 2001 (Article No. 1; Pages 30-31)

Further background regarding prismatic tracking is available in U.S. Pat, Nos. 4,382,434 and 4,377,154, both by the present inventor.

Simple Bulk Optic Offers Simple Beam Control

Bulk solid optics have helped circumvent the need to align multiple free-space optics within communications systems by substituting multiple mountings of discrete optical components with a single integrated optical unit. The same goal spurred interest at NEC Research Institute in Princeton, N.J., in a bulk optic filtering device called an X-cube.

Developed by Jan Popelek and Yao Li, who have since moved on to Phaeton Communications Inc. in Fremont, Calif., the assembly bonds four identical right-angle rooftop prisms that touch at the center. This forms a cube with two mutually orthogonal and intersecting internal planes that look like an “x.” Each prism has a 5-s angular precision for the 90-degree angle and a 15-s precision for both baseline angles. Interferometric measurement of all three optical planes showed that their surface flatness was within one optical fringe.

Depending on how the interior surfaces are treated, the cube could serve as a lossless 4×4 beamsplitter, a star coupler or a wavelength division multiplexing applications. In preliminary experiments, Popelek and Li applied a dielectric coating on one rooftop plane of each prism. The coatings transmitted 50 percent of the 1300-nm light. They attached two fiber collimators to each side of the prism housing to act as an optical input and output.

The cube was made and mounted by hand. Its dimensions were 35 mm without the housing. At those dimensions, it was possible to align the collimators with a screwdriver, but Popelek noted that cube size depends on the size of the collimator. With added polarization controls, the cube demonstrated a 2.1-dB insertion loss and uniformity variance of 0.279 between channels.

The most difficult part of the cube's manufacture—optimizing angular alignment—was also its most crucial. Most of the 2.1 dB loss came from angular misalignment between collimators, said Popelek, who added that precision was most important at the rooftop angle of each prism.

“If you can't make it perfectly 90 degrees then you can't glue them together effectively, and your losses multiply,” he explained. Part of this problem presumably could be worked out in a manufacturing process.

NEC Research has not pursued development of the X-cube since Popelek and Li's departure, according to a company spokesman.

Photonics—December 2001 (Article No. 2; Pages 122-125)

Dynamic Dispersion Compensation: When and Where will it be Needed?

As optical networks increase data rates to 10 Gb/s and beyond, the effects of chromatic and polarization mode significant. This has ignited interest in dynamic or tunable dispersion compensators that, unlike static compensation methods optimized for—and limited to—a specific wavelength range, compensate for dispersion equally for each wavelength.

Although questions remain about if, when and where networks will require tunable dispersion compensation, component manufacturers are pursuing several solutions to the problem, each presenting advantages and disadvantages.

Static methods already exist to compensate for chromatic dispersion, which has two parts:

Material dispersion, which is the variation of the dielectric constant with frequency.

Wavelength dispersion, which is the nonlinearity of the propagation constant with frequency.

Material dispersion is the more important of the two. Depending upon the refractive index of the medium, the propagation characteristics of each wavelength within a pulse differ. This results in varying travel times for each wavelength: The longer wavelengths travel more quickly than the shorter ones, producing a change in dispersion slope and, ultimately, widening the light pulse.

As the light pulse widens, so does each wavelength within the pulse. The combined result is chromatic dispersion. The phenomenon increases linearly with distance and also a squared increase of the data rate.

With 10 Gb/s transmission expected to gradually replace 2.5 Gb/s as the most common data rate in long-haul and many metropolitan networks, it is clear why chromatic dispersion is expected to be an increasingly urgent problem. The likelihood of widespread 40 Gb/s networks within the next four or five years makes the matter even more urgent.

Of equal importance to the future of 40 Gb/s systems is a means to compensate for polarization mode dispersion. If single-mode fiber were circular along its entire length, polarization dispersion would not be an issue because light's two orthogonally polarized modes would travel at exactly the same speed down the span. In reality, fiber may have different stresses and strains and, therefore, potentially different diameter dimensions in various areas of the span. As a result, either mode has a slightly different path along the fiber and travels at varying speeds.

This problem is caused mainly by lack of process control in the early manufacture of the fiber itself. Before 1995, millions of miles of fibers were manufactured without stringent specifications on “roundness.” As data rates and lengths increase in these fibers, polarization mode dispersion becomes even more pronounced.

Because the wholesale replacement of older optical cabling is not economically feasible, the move to 10 Gb/s creates a need for dispersion compensation. Indeed, this need will not go away entirely, even when more modem cabling is widely installed, because temperature and stress variations over time cause changes in the diameter of the fiber. This is less of an issue with more recently manufactured fiber, but the concerns with temperature and stress changes remain. The dispersion compensation market generally consists of two segments:

Dispersion-shifted fiber or non-zero dispersion-shifted fiber used for new installations.

Dispersion compensation modules that contain dispersion-compensating fiber.

Modules are the simplest way for systems manufacturers to incorporate compensation into existing 10 Gb/s networks. Initially, dispersion compensation was not part of the design for OC-192 systems. Equipment manufacturers quickly discovered that this was a mistake and, needing a “quick fix” for existing products, developed dispersion compensation modules as the solution.

The modules have limitations; namely, that they linearly compensate for dispersion over a wavelength range rather than equally compensate every wavelength. However, the solution was good enough for 10 Gb/s signals passing over single mode fiber spans of 80 km, as long as the signals were then amplified and compensated again.

Because the service providers and equipment manufacturers want to lengthen the spans between amplified and regenerators, to increase data rates to 40 Gb/s and to decrease channel spacing, new methods of chromatic dispersion compensation shall address issues that dispersion compensation fiber does not: chromatic dispersion slope mismatch—which depends on the type of fiber in the transmission path—and compensation of each separate wavelength.

Polarization mode dispersion is also an issue at higher data rates, and component suppliers plan eventually to integrate compensation for it with that for chromatic dispersion. For now, they are concentrating on addressing each problem separately.

For chromatic mode dispersion, static compensation measures include readily available dispersion compensation modules, chirped fiber Bragg gratings, high-order mode fiber devices and virtual-image phased arrays.

Tunable birefringent filters are the most evident compensation method for polarization mode dispersion.

Based on our analysis, it appears that tunable compensation methods will replace both dispersion-shifted fiber and the dispersion compensation modules developed as a patch for OC-192 systems. Unlike either of these established techniques, tunable methods can compensate dispersion for each wavelength by the exact amount needed.

However, there does not seem to be a clear winner among tunable approaches yet, and there is no indication that such a winner will appear anytime soon. Equipment manufacturers continue to make decisions based on their specific architectural and technical needs.

We [referring to the authors of that article, not the present inventor] believe that networks will not require tunable dispersion compensators for most 10 Gb/s systems, where existing compensation modules should satisfy most requirements. Dynamic compensation methods could be necessary, however, in ultralong-haul 10 Gb/s systems, or in networks with low-quality fiber or many splices.

Tunable dispersion compensators will become necessary as system speeds increase to 40 Gb/s or channel spacings decrease in dense wavelength division multiplexing systems.

Consequently, the market for tunable dispersion compensation should follow the same general growth patterns as products for high-speed modulation and finer channel spacing. However, it remains to be seen how the market for current types of dynamic dispersion compensation technology will be divided. No one method of compensation will satisfy all customer specifications and, therefore, it is probable that they will all coexist.

Photonics—December 200______ (Article No. 3; Pages 126-128)

### BRIEF DESCRIPTION OF THE DRAWINGS

A more complete understanding of the present invention may be derived by referring to the detailed description of the invention and claims when considered in connection with the Figures, wherein like reference numbers refer to similar items throughout the Figures, and:

FIG. 1 is a diagram of a wireless holographic-division multiplexing and demultiplexing system;

FIG. 2 is a diagram of an optical network with add/drop multiplexer;

FIG. 3 is a diagram to which reference will be made in describing the relationship among system bandwidth, modulation, bandwidth and channel spacing;

FIG. 4 is a diagram to which reference will be made in describing the modulation bandwidth of higher-speed signals;

FIG. 5 is a diagram illustrating the performance of a volume-phase holographic grating;

FIG. 6 is a cross-sectional diagram of a volume-phase holographic grating;

FIG. 7 is a diagram to which reference will be made in describing DWDM bandwidth in relation to EDFA bandwidth;

FIG. 8 is a diagram of an embodiment of a wireless laser beam communications system;

FIG. 9 is a diagram of another embodiment of a wireless laser beam communications system;

FIG. 10 is a diagram of another embodiment of a wireless laser beam communications system;

FIG. 11 is a diagram of another embodiment of a wireless laser beam communications system;

FIG. 12 is a diagram of another embodiment of a wireless laser beam communications system;

FIG. 13 is a diagram of another embodiment of a wireless laser beam communications system;

FIG. 14 is a diagram of another embodiment of a wireless laser beam communications system.

FIG. 15 is a diagram of another embodiment of a wireless laser beam communications system;

FIG. 16 is a diagram of another embodiment of a wireless laser beam communications system;

FIG. 17 is a diagram of another embodiment of a wireless laser beam communications system;

FIG. 18 is a diagram of another embodiment of a wireless laser beam communication system;

FIG. 19 is a diagram of an interleaver;

FIG. 20 is a diagram of a modem communications system;

FIG. 21 is a diagram of a local area network;

FIG. 22 is a diagram of a communications device; and

FIG. 23 is a diagram of an attache case especially equipped to facilitate PDA operations.

### DETAILED DESCRIPTION OF THE INVENTION

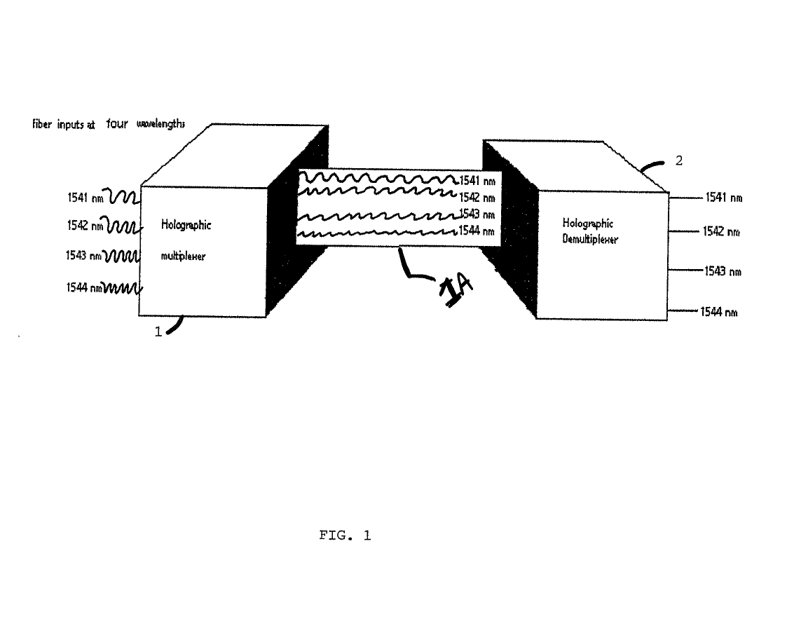

In a simple point-to-point WDM system, light sources generate modulated signals at multiple wavelengths (see FIG. 1). In general the sources are separate. However a single broadband source can also be used with proper optics to supply all the wavelengths. In that case each optical channel is modulated separately, either by directly modulating the source or by employing an external modulator. The optical channel 1A between multiplexer 1 and demultiplexer 2 may be a fiber optic cable or a wireless optical connection (e.g., a beam), or the like.

Optical Networking

The proposed integrated wireless laser beam (WLB) system is not only for simple point-to-point connections. Operating “long-range” systems require amplification or regeneration of signals. Early fiber optic systems used repeaters, which converted the optical signal to electronic form, then regenerated a new optical signal. This proved impractical for wavelength-division multiplexing because each wavelength needed a separate regenerator. Optical amplifiers work far better for WDM systems because they amplify all wavelengths in their operating range. For example, the standard C-band erbium-doped fiber amplifiers, now widely used in telecommunications, can amplify signals at about 1525 to 1570 nm.

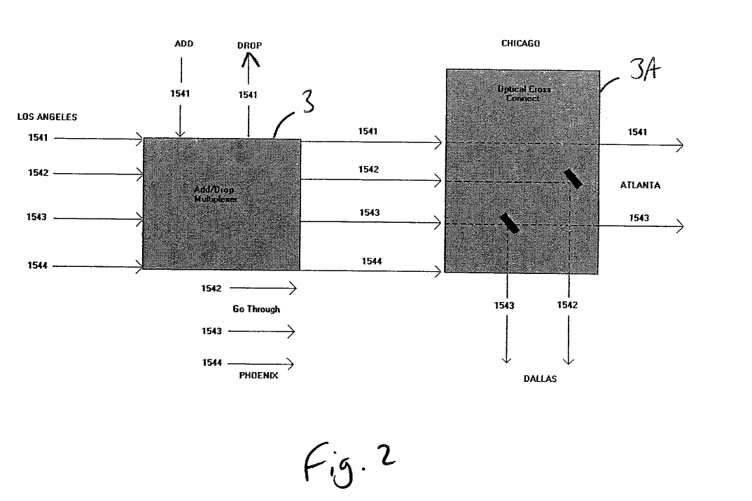

Advanced optical networks also require the capability to direct or switch individual wavelengths to different wavelengths and to different destinations. Optical add/drop multiplexers 3 split one or more wavelengths from a WDM (or DWDM) signal, adding one or more wavelengths as illustrated in FIG. 2. Optical cross-connector 3A routes particular frequencies.

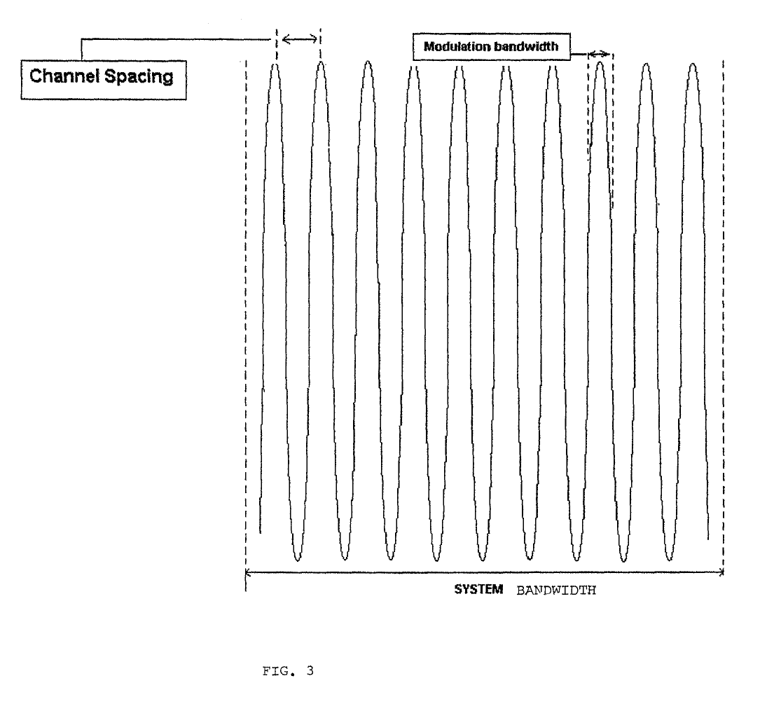

The number of channels available is often limited by the bandwidth of the fiber optic transmission system (see FIG. 3). What sets the optical bandwidth limit depends on the type of system. In long-distance systems, it is the optical amplifiers.

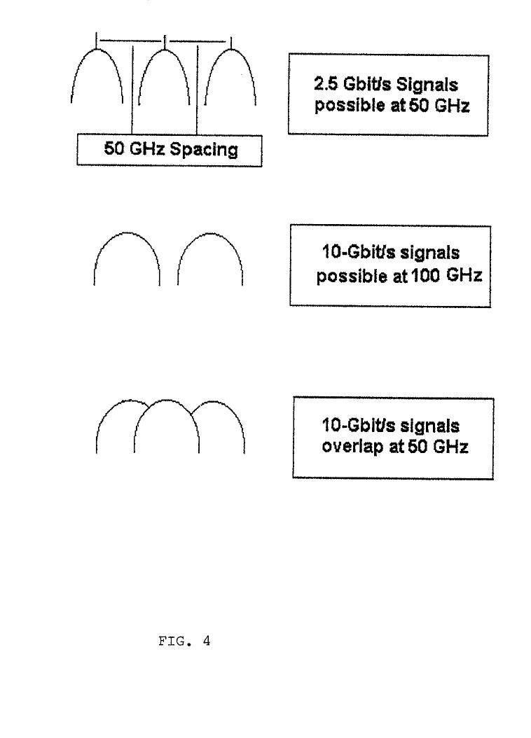

Modulated source bandwidth, for example, poses the ultimate limit on how closely wavelength channels can be squeezed together. Often a WDM laser source has a spectral bandwidth of only a few gigahertz, but modulating the signal (even with an external modulator) adds other frequency components to the signal, spreading it over a broader range. The higher the modulation rate, the broader the frequency spreading and the broader the resulting bandwidth (as illustrated in FIG. 4).

Principal WLB Features

The principal features of the WLB system of the present invention which follow are intended to result in a fully integrated high volume capacity space-to-land based system employing, wherever possible, co-developed or leased towers, and vice versa for video, voice and data communications with seamless information flow to fiber optic and/or photonic landlines and direct communication to connected users via satellite dishes or towers (i.e., last mile) or mobile users now limited by current RF (phone) wireless technology to comparatively slow speed and/or messaging transfers.

In this field, I have two (2) earlier published technical papers. The first, a CASA peer reviewed paper, is entitled “Networked Space Power Generation Can Reduce Mission Cost” and the second, a ASME peer reviewed paper, is entitled “Continuous Power Generation in Space”. Both were published in 1997.

The above referenced CASA and ASME papers were published following the filing by me of U.S. patent application Ser. No. 375,385, dated Jan. 17, 1995 (resulting in U.S. Pat. No. 5,685,505). The patent also made specific reference to use of lasers for both power and communications (see Column 3, lines 60-65).

Other Spectrum Methods

Another RF technique known as spread spectrum timing or “clocking” may also be adapted to the proposed WLB using blended RF frequencies and optical wavelengths to provide greater security, when desired.

Use of advanced spread spectrum-modulation hardware is currently available to precisely generate, control and synchronize multiple rectenna with secure frequency and/or wavelength hopping patterns. Accordingly, if a non-approved user's rectenna is not synchronized to the transmitted frequency or wavelength or if tuned to only one of the frequencies or wavelengths in use he/she cannot successfully decode this information.

Accordingly spread wavelength spectrum clocking may also be employed to eliminate the need for specialized encryption equipment where secure integrated voice, video or data bandwidth is required.

Recalling that Shannon's Information Rate Equation defines C, the capacity in bits per second, W, bandwidth, S, signal power, and N, noise power, as C=W*log (1+S/N). One can readily see from above Shannon relationship, that as W increases, a lower (S/N) ratio is required for any given capacity (C) requirement. Accordingly spread spectrum technology can be used to process appropriate spectrum optimized modulation methods, high bandwidth rates, content security, reduced EMT and increased range for any given transmission power level due to its inherently “lower optical or RF signal to noise” ratio (S/N) requirements, etc.

WLB System Benefits

In summary, the WLB scenarios described herein utilize WLB dispersive components employing volume-phase holographic gratings and offer:

Improved separation performance for current optical networks and promise to meet the needs of next-generation systems;

Provide high bandwidth connectivity between, and co-location facilities in, major global population centers;

Make feasible the development of a technologically advanced, high-capacity, low-cost network;

Extended reach for our WLB network through interfaces with existing installed fiber capacity;

The utilization of important recognized Internet standards, e.g., WAP and MPLS. These standards can be seamlessly interfaced with existing Global Positioning System (GPS) and Global Navigation Satellite Systems (GNSS) to accommodate all mobile RF, B to B or E-commerce for low power laser or non-fiber optic devices, i.e., Palm and similar mobile device traffic in a fully seamless yet traceable manner, capable of transmitting optically coded information at a high rate approaching approximately 8-9 gigabits per second rate for use in wireless streaming data and video Internet or other communications.

Permits detection of separate wavelengths at the receiver or rectenna.

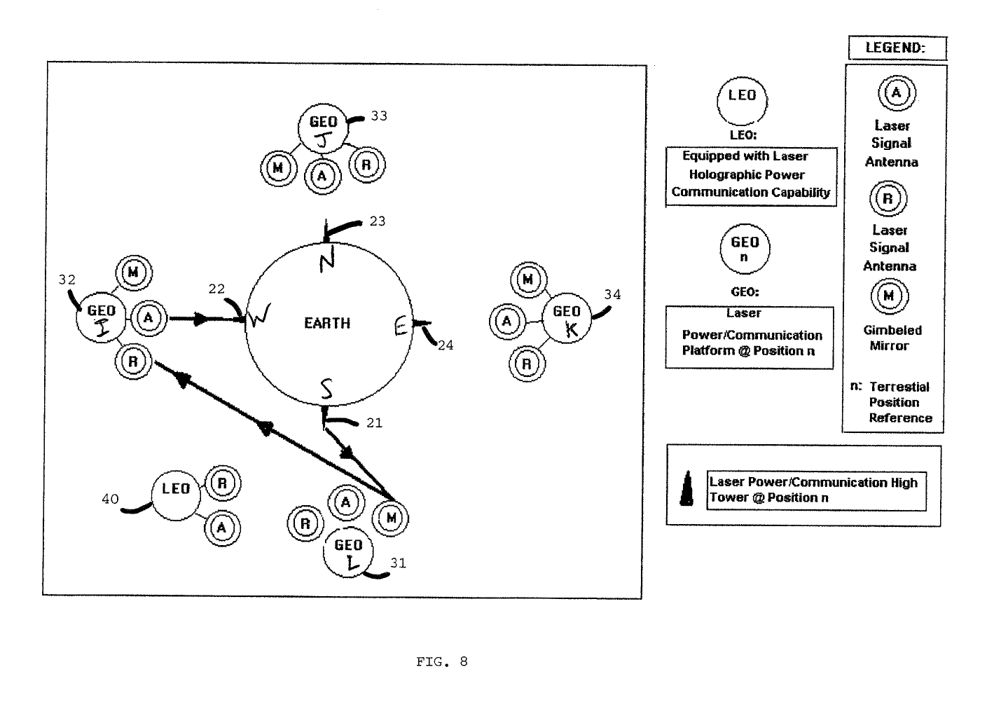

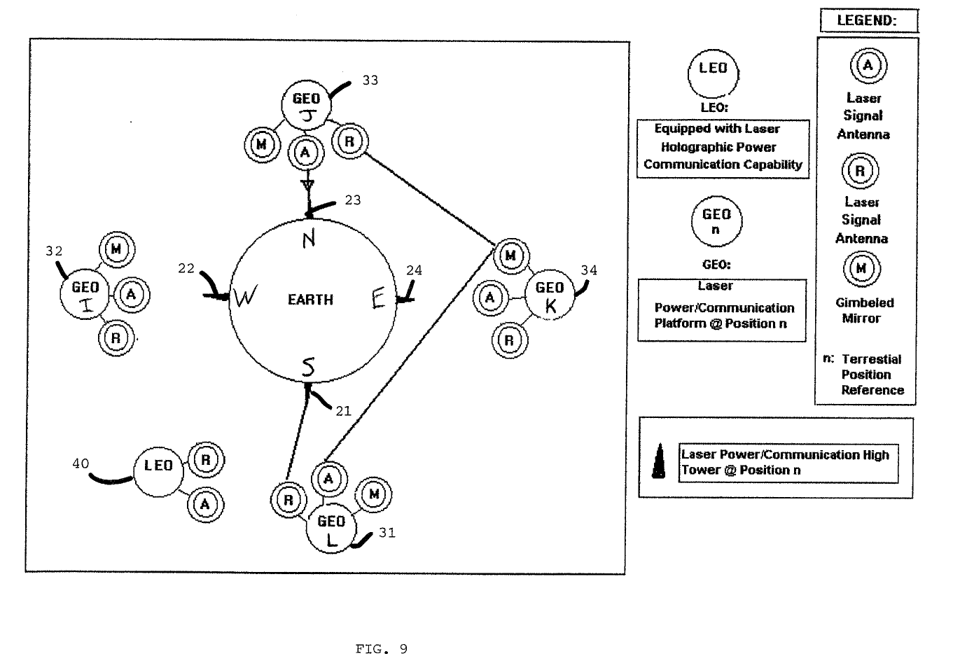

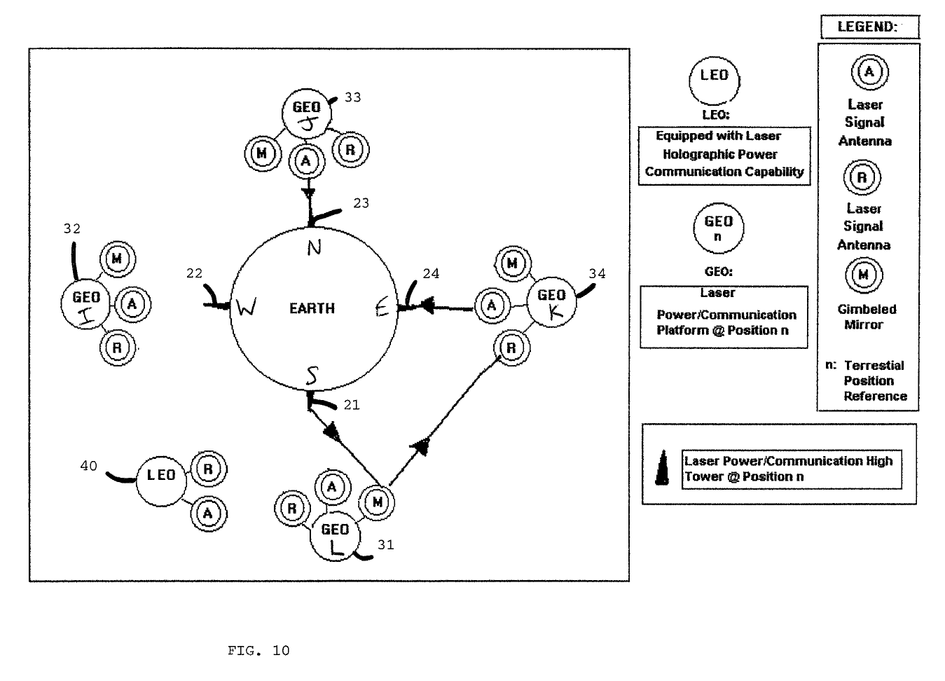

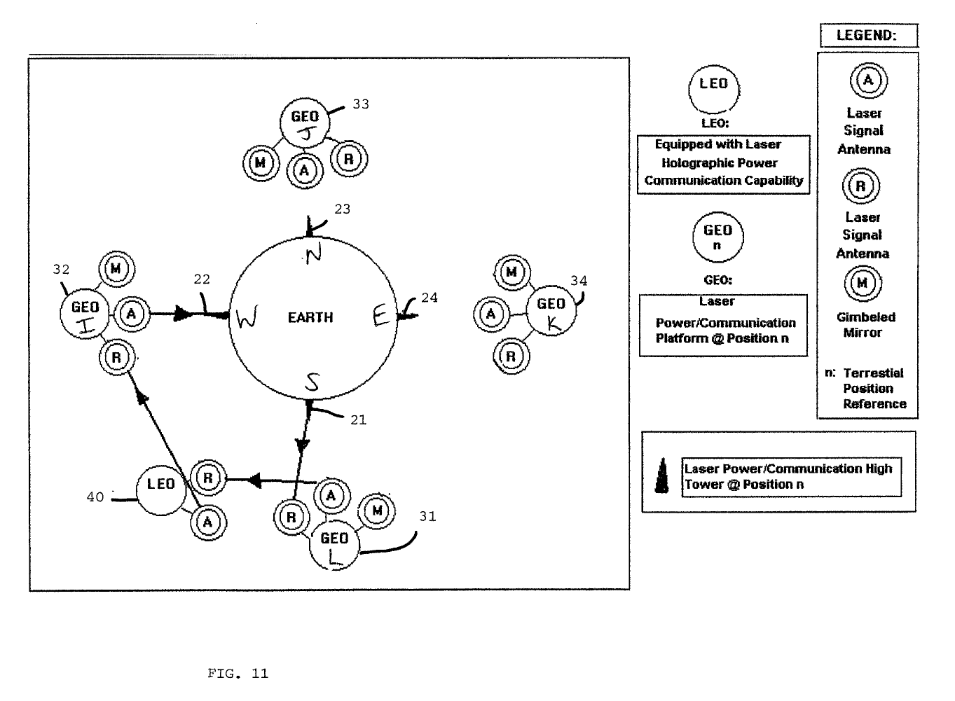

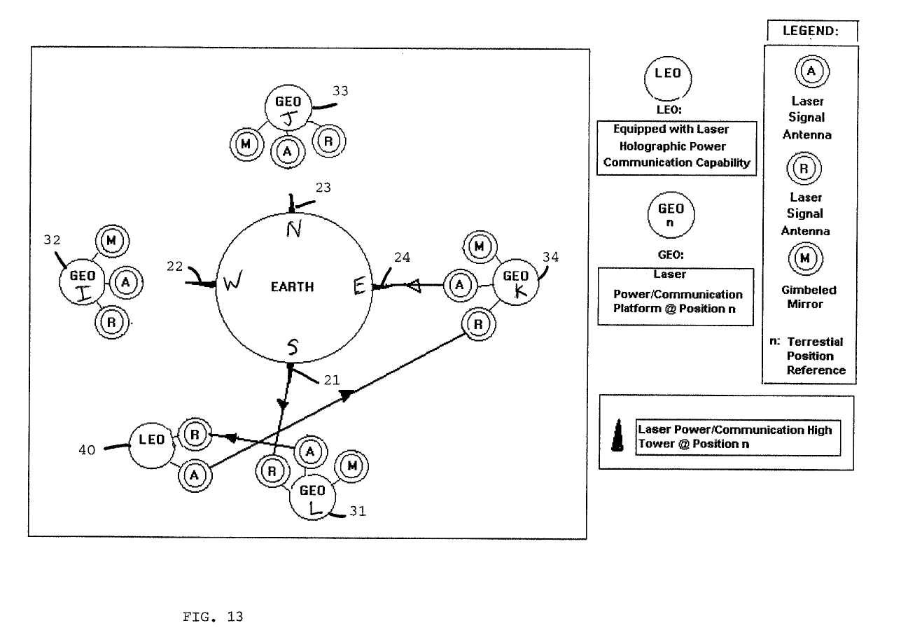

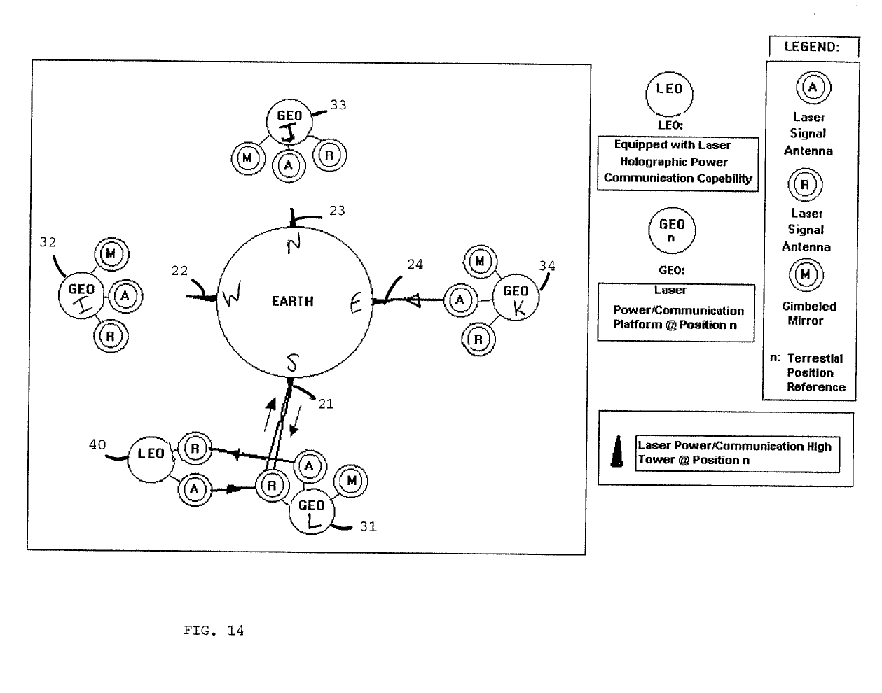

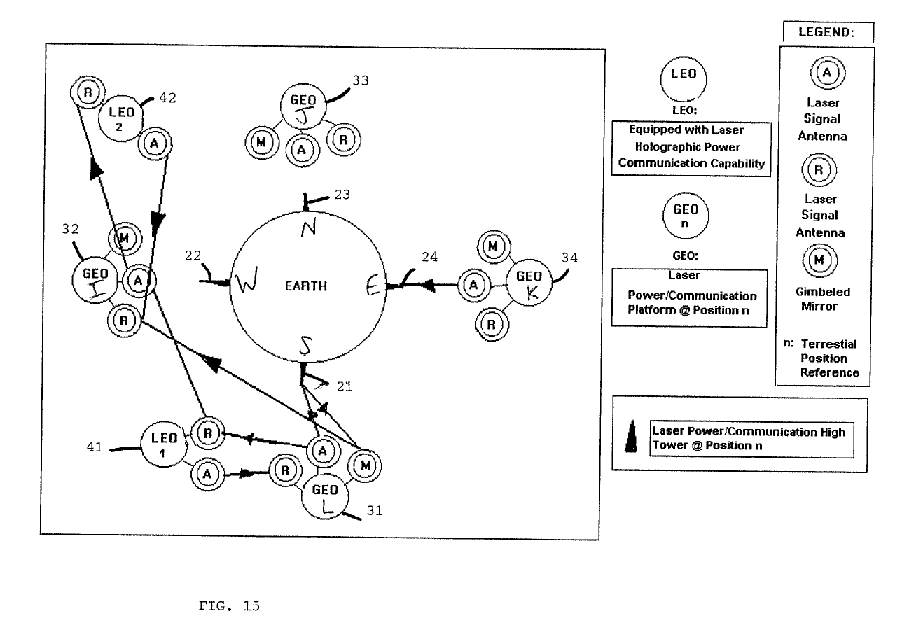

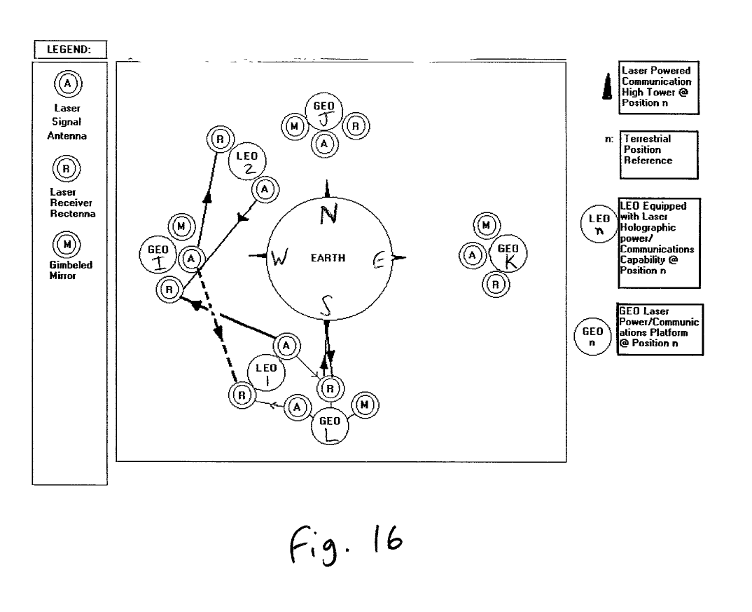

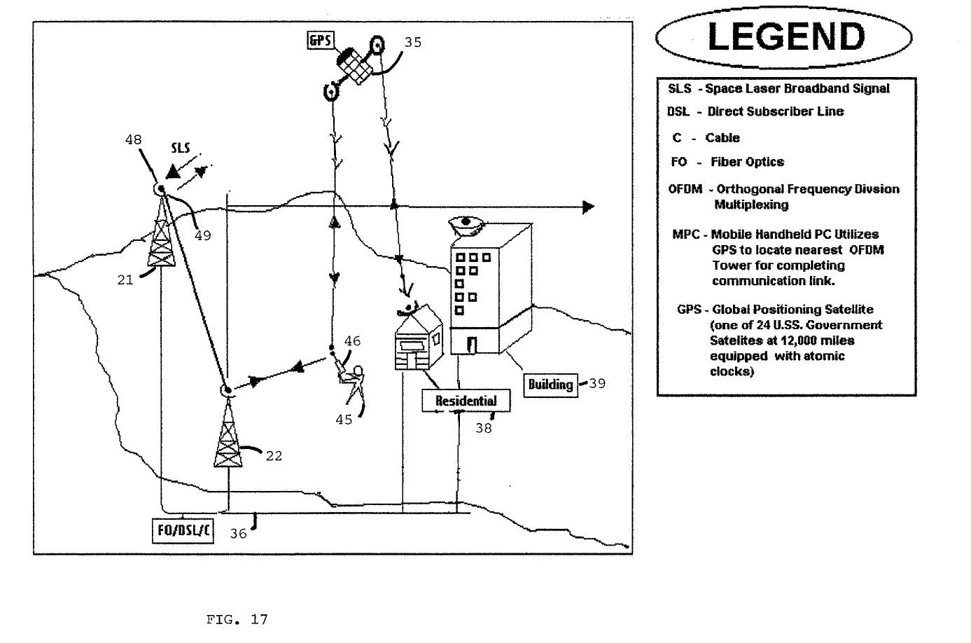

FIGS. 8-18, inclusive, illustrate many of the applications referred to above. In each of FIGS. 8-16 signal paths for laser beam communications are indicated with arrows. In FIGS. 17-18 signal paths are indicated with arrows and with solid lines.

Another scenario involves directing one-way streaming video, data and/or voice optically via WLB from either elevated communication towers or viewing GEOs as users in a similar manner to that described for land based mobile communication under scenarios depicted in FIGS. 17-18, for example.

In this way, each user can address and identify billable income stream yet present it to the initiating user in the same format as one's current telephone bill. Furthermore, implementing interconnection to holographic multiplexing/demultiplexing holographic devices, a higher gigabit/second rate than possible with comparable RF devices is achieved.

The WLB system of the present invention makes high speed bandwidth more affordable, secure, sealable and reliable than, for example, T-1 connections or DSL, which have often failed to meet user expectations in transmitting foreseeable streaming voice, data and video at greater rates than current commercially available, e.g., gigabit/second rates. The principal attraction remains in that WLB multiplies the transmission capacity of a signal interfacing with a single fiber by the number of optical channels it can carry in a manner providing problem-free performance at a reasonable cost.

Definitions of Major Protocol Terms Used

WAP, as referenced above, stands for Wireless Application Protocol. It is a standard developed by WAP Forum, founded earlier by a number of mobile data communications companies, for instance Nokia, Ericsson, Motorola and Phone.com. The WAP standard facilitates delivery of information to lightweight, wireless communication devices, e.g., mobile phones and other personal hand-held devices. The WAP protocol is similar to the ‘regular’ HTTP protocol used for traffic across the Internet. This means that in WAP a lot of things appear as ‘traditional’ web applications.

Space-based radio positioning systems, i.e., Global Positioning Systems (GPS), also referenced earlier, provide 24-hour three-dimensional position, velocity and time information to suitably equipped users anywhere on or near and sometimes above the surface of the Earth. Global Navigation Satellite Systems (GNSS) are an extension of GPS systems, which provide customers and other users accurate information for critical navigation applications. The NAVSTAR system is operated by the U. S. Department of Defense and is the first GPS system widely available to civilian users.

While most other providers of wireless transmission currently rely upon use of the IEEE 802.1b Standard to deliver their content as unified voice, media, data and fax messaging to information appliances (at a 11 megabit per second rate) often requiring high-cost customized, enabling software including costly analog-to-digital or and/or digital-to-fiber optic switching, etc. Finally, another protocol, namely the Multi Protocol Label Switching (MPLS), also referenced above, can be applied directly to fiber, as well as for IP-based communications, particularly since over one half of all communications will probably be using this protocol within the next 18-24 months. It basically eliminates the need to have a SONET or ATM layer to operate, and can operate directly from an end user device to the fiber transmission layer.

Key Elements of Invention

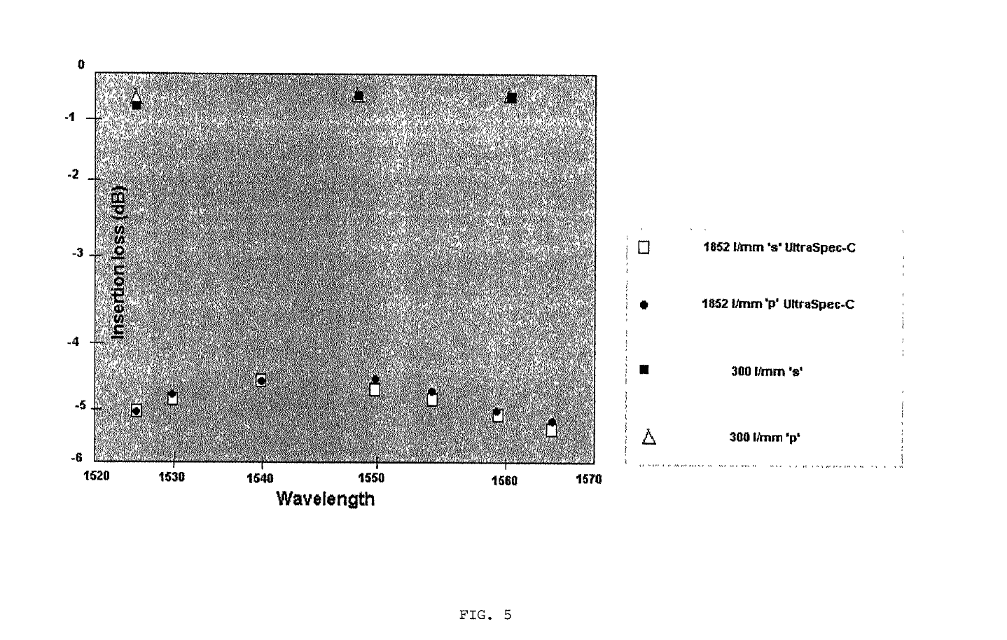

My invention employs low transmission power laser wireless technology interfacing with a volume phase holographic grating (see FIGS. 1-6) in combination with preferably but not limited to a DWDM-compatible multiplexed and demultiplexed laser beaming strategy to avoid the obvious pitfalls of earlier deployed Iridium, ICO and Globestar multi-satellite fleets, the hassles of radio spectrum rights and ITU international protocols, etc. for point-to-point long distance space bandwidth communications. This approach provides significant advantages when handling high gigabit rates of streaming video, audio, voice and data utilizing holographic line focus spectrum splitting (see U.S. Pat. No. 5,685,505).

The separation and/or recombination of numerous closely spaced wavelengths as illustrated earlier in FIGS. 3 and 4 is a key task in several telecommunication applications, including wavelength-division multiplexing/demultiplexing (WDM), and optical add/drop multiplexing (OADM). There are several technologies already available on the market for performing these functions, all of which involve various trade-offs in cost, performance, and practical implementation as pointed out earlier. As optical networks move toward larger channel counts, which involve even more closely spaced wavelengths, utilizing a volume-phase holographic grating can provide the performance necessary for advanced high capacity and speed optical networks. Accordingly the proposed WLB invention can be used to manufacture high quality bandwidth communications for both stationary and mobile users to allow them to be positioned to meet the needs of next-generation DWDM systems.

Diffraction gratings are optical elements used in a wide variety of industrial and scientific applications. Surface relief diffraction gratings consist of a series of closely spaced grooves on a glass or plastic substrate. When light of multiple wavelengths is incident on a grating, each wavelength is transmitted (or reflected) at a different angle, thereby allowing simple separation of the constituent wavelengths.

Yet, surface relief gratings are relatively fragile. For example, any contamination of, or contact with, the diffractive surface during fabrication, assembly, or use may seriously degrade performance. Also surface gratings generally have a high sensitivity to input-polarization state and a spectral response that is not flat.

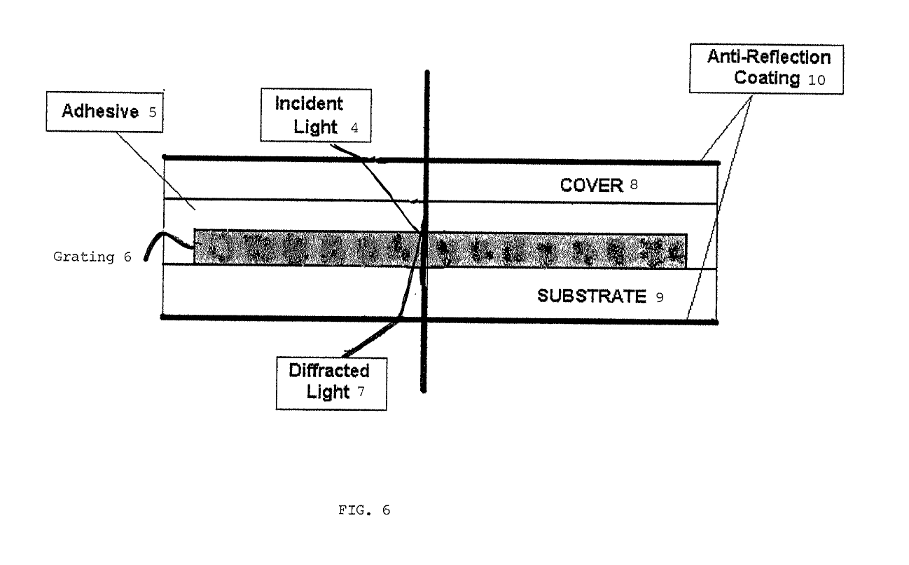

The volume-phase holographic (VPHG) grating effectively addresses these issues (see FIG. 6). To produce a VPHG grating, an optical substrate 9 is coated with a layer of dichromated gelatin from a few to many microns in thickness. This holographic film is exposed to an interference pattern produced by combining two mutually coherent laser beams. The exposure produces a slight, typically sinusoidal variation or modulation in the index of refraction in the material. This index variation occurs throughout the entire volume of the film, not just at the surface. This produces a grating 6. After the grating has been processed to obtain high efficiency, it is laminated to glass cover 8.

Because a volume grating is optically thick, the efficiency profile of the imaged light is governed by Bragg diffraction. The light path at the Bragg condition through a transmission VPH grating having fringes orthogonal to the grating surface is shown in FIG. 6.

The VPH grating offers numerous practical and performance advantages over conventional surface relief gratings. Encapsulation between a glass substrate 9 and a glass cover 8 protects it from the environment and handling, and also enables it to be coated with antireflection coating 10 to minimize reflection-insertion loss (see FIG. 6). In addition, low polarization sensitivities are possible with both low and high dispersion transmission gratings. Since each manufactured grating is an optically recorded original, there is no grating replication errors and existing manufacturing processes are capable of economically producing components that approach theoretical design parameters. Finally, customized complex gratings structures can be produced to accommodate packaging constraints or improve optical performance.

Accordingly, I propose to utilize a dual mode VPHG serving in both a multiplexing and demultiplexing modality with a holographic multiplexer 1 and holographic demultiplexer 2 pair for sending and receiving wireless laser beam communications as shown in FIG. 1. Alternatively, multiplexer 1 and demultiplexer 2 may be coupled via a fiber optic channel that carries laser beam communications signals.

Operational Modalities

Following are some selected scenarios (as shown in FIGS. 8-18,) which depict preferred operational modes hereinafter described. Only a total of four geosynchronous earth orbit satellites (GEOs) and low-earth orbit satellites (LEOs) are needed for full deployment earth coverage (four GEOs 31-34 and LEO 40 are nevertheless shown to facilitate description).

It is proposed that an initial deployment over North America will require only one strategically placed GEO along with leased space for equipment on existing or co-developed towers erected at selected urban sites. This will include interfaces with existing fiber (and/or lens) photonic (FO) landlines, which extend from strategically placed elevated fiber optic elevated towers 21, 22 (see FIGS. 17 and 18) and which are capable of both sending a beaming uplink and receiving beaming downlink laser powered broadband communications from one of four GEOs via holographic signal generators/collectors, which feed into both FO and/or DSL landlines 36 for direct connection to all residential 38, buildings 39, facilities, etc., served. For the presently costly “last mile build out”, similar holographic signal collectors 48 (i.e., rectennas) would be used to receive communications beamed down from GEOs and would be equipped with smaller signal generators 49 (i.e., antenna), which would beam directly to nearest locally available multi-point OFDM or low power laser antenna mounted on local area towers for local covered area use as shown. For all out-of-area use, signal would be sent via indicated FO landlines 36 (which are shown interconnected) with above-referenced elevated FO towers for beaming signal uplink to overhead GEO 31-34 for immediate dispatch to a particular user.

GPS satellites 35 (shown) serve to identify both time and location of broadband users (either sending or receiving), thereby facilitating the networking of all tower and GEO incoming broadband communications.

Referring again to the scenarios depicted in FIGS. 17 and 18, notice that mobile RF communications are also networked by means of GPS satellites 35 with a record preserved in a proprietary software at the time of use. The GPS 35 will be used to redirect traffic to the nearest OFDM or low power laser antenna mounted on local area tower 21, 22 using GPS integrated software, routers, etc. The latter can redirect broadband communications via RF to local area mobile users 37, 45 for voice or convert to FO signal for export transmission via interconnected elevated tower to point of delivery as needed via GPS integrated software, routers, etc. means as described above, to any other point, which can be seen from any one of the four (4) operational GEO/LEOs in the manner described above. LEOs are inserted for use between adjacent GEOs in a predetermined orbit and spaced to provide optimum coverage for both designated space-to-space, space-to-earth, and earth-to-space needs.

Employing software to facilitate integration with existing GPS (and GNSS) satellites eliminates the need for excessive numbers of orbiting LEOs used in earlier business models (Iridium, ICO, Globestar, etc.) to direct/receive RF wireless traffic. Building upon already existing GPS and GNSS satellite capabilities permits one to delay in constructing a worldwide laser broadband system network, otherwise needed to assist identify time of use and facilitate transfers among numerous users.

Referring to scenarios depicted in FIGS. 17 and 18, notice that for voice, data or video streaming information generated and/or transmitted locally without benefit of GEO or LEO satellites illustrated in FIGS. 8-18, inclusive, laser wireless information can be transmitted either from a local OFDM tower 21-24, a commercial or residential-type building 38, 39, to moving (mobile) user 45 with MPC 46 or when driving in auto 37 equipped with viewing rectenna.

Referring to the dual mode VPHG receiving/sending OFDM tower 21-24, the antenna 49 and rectenna 48 each consist of a suitable size, preferably endless, circular ring shape encasing holograph with a continuous slit opening, preferably facing down at a broad, pre-selected coverage angle, and serving as both dual mode (signal sender multiplexer) antenna and (signal receiving demultiplexer) rectenna to/from any viewing hologram with similar functional dual mode stationary or mobile PC (hand held) positioned below but inclined at the appropriate azimuth angle for optimized reception.

According to another embodiment, a solar-powered attache case illustrated in FIG. 23 which when used outdoors will be interconnected by plug-in wire connector or wireless coupling to hand held mobile PC or PDA is provided. The preferred wire connection is a fiber optic connection for high bandwidth communications. For slower speed communications, wireless communication (RF, IR or the like) to the modem is preferred.

A suitably protected solar panel could be built into the side of the attache case along with a similarly protected holographic linear multiplexer and demultiplexer which can be placed on a horizontal surface and accordingly have its azimuth angle adjusted manually or automatically to optimize available signal strength by use of an interconnected signal strength indicator. Preferably, the azimuth angle of the inside case is adjusted until a maximum signal strength is detected on the signal tuning gauge. Once maximum signal strength is detected, the cover of the attache is locked in place.

Azimuth angle synchronization can also be confirmed by means of optical signal (or equivalent means) manual or automatic adjustment to confirm OFDM receipt or other designated delivery point as shown, for example, schematically in scenarios depicted in FIGS. 17 and 18. For both remote and hand held/stationary wireless PC's, a hologram multiplexer or demultiplexer can employ either WDM or DWDM technologies as discussed above. The need to handle an ever increasing demand for more data and Internet driven information has accelerated the demand for fiber optic transmission, and resulted in a concurrent explosion in multi-channel DWDM operating in conjunction with angle tunable interference filters (which are stable can be manufactured at reasonable cost; and are capable of maintaining a narrow bandwidth at lower insertion loss). Other tunable filter methods include use of surface relay diffraction/gratings, etalons, or linear sledding filter technology, which may be applicable depending upon circumstances. Wavelength tuning for example can be useful in accommodating a wide tuning range, low polarization dependence, low insertion loss and narrow bandwidths for fiber optics. Trade-offs between spacing of optical channels (in fiber optics or employing holographic VPHG's) and the maximum TDM data rate per channel exists as more of a cross-talk problem with fiber optics than with WLB according to the present invention. This appears to offer significant benefit for DWDM in view of inherent WLB improved separation performance for current optical and next generation systems and closely spaced wavelengths for DWDM and optical add/drop multiplexing (OSDM) which is required for communications applications (see FIG. 2 above) optical signals can accordingly be easily read after demultiplexing at users' hand held or mounted on a moving vehicle (e.g., on a car, truck, bus, train, plane, etc.) receiver as a continuously moving stream (right to left) of works displayed with appropriate grammatical format for ease of understanding.

It is also intended that such advanced hand held devices 46 may differ from current commercially available “Palm” or similar hand held devices in the following particulars:

May utilize advanced high-speed voice recognition software for all input instructions thereby eliminating alphanumeric keypads, etc;

May have only a power on/off button to activate/deactivate mobile PC;

May use advanced micro-camera palm or eye scan means for user recognition/billing, thereby eliminating the need for passwords;

May maximize actual screen size through elimination of space required for above conventional input modalities; and

May provide mobile PC with separate dual mode VPHG (rectenna/antennas) holographic enclosed films for linear configured (i.e., laser point source collection) signal input/outputs for maintaining on imbedded automotive vehicle top or, if hand carried, fitted within attache type case side panel with umbilical connection to hand held PC, as earlier discussed.

An attache case with holographic dual mode reception/transmission capability (assuming solar powered for outdoor use with utility plug for indoor use, etc.) where user is in view of overhead tower/satellite can be positioned so that low power WLB signals compatible with both WDM or DWDM fiber optic networks are sent through a window or via a building central, fiber optic system installation. Activated manually or automatically by means of signal maximizing servo motorized side panel imbedded in attache or equivalent case as earlier described having outside face of case adjusted with dual mode VPHG's to optimum available signal azimuth angle for foreseeable mobile PC/WLB signal strength combination. It is understood that attache case would be provided with appropriate electronic means confirming each such point to point “wireless communication” transmission to OFDM or other desired user destination target, etc.

Other Enabling Technologies and Benefits

Although DWDM using erbium doped fiber amplifiers are preferred for accurate long distance transmission of streaming voice, video and data, a possible alternative for local access metropolitan markets is so-called coarse WDM (CWDM) which offers distinct advantages for short-haul, unamplified networks, e.g., lower equipment costs resulting from the use of uncooled lasers and related components manufactured to less stringent tolerances than required for DWDM.

The promise of combining such local fiber RF and wireless networks could also serve to reduce the current high cost of optical-to-RF, analog to digital, etc., splitters, relays and related components, which tend to impede growth of this market. CWDM may provide a better balance of price and performance needed for rapid growth of this unique market. CWDM enables local access in much the same way that DWDM enabled the long-haul market.

As earlier pointed out both DWDM and CWDM are variations of WDM. DWDM is generally the implementation of WDM over long distances and CWDM is generally the implementation of WDM in metropolitan and local access markets. The different requirements of these two markets frame the various architectures and drive the performance requirements of the proposed system multiplexing and demultiplexing components.

Initial DWDM Implementation

The development of the erbium-doped amplifier (EDFA) has been the primary enabler for the proliferation of high-bandwidth long-distance networking by significantly reducing the need for costly re-amplification, reshaping, retiming, and regeneration equipment. The EDFA's inherent ability to simultaneously amplify multiple signals independent of the wavelength and bit rate allows network operators to offer low cost capacity in DWDM systems.

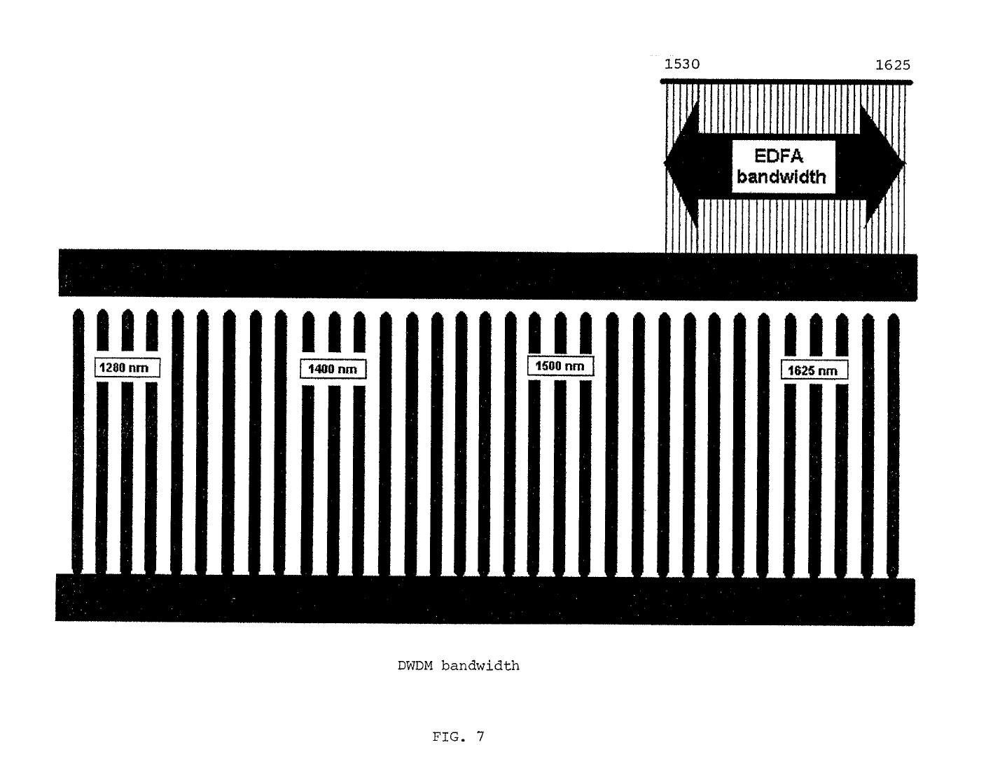

The architecture of long-haul DWDM systems demands high performance components. I envision the deployment of all-optical DWDM systems with more channels, longer spans, and wider wavelength spectrums. The typical wavelength change of a distributed feedback Chip DFB is 0.08 nm/C. Consequently in DWDM systems, one uses costly packaging techniques (e.g., butterfly housings with thermoelectric coolers, etc.) to prevent the wavelength from drifting. In DWDM systems, however, cost reductions can be achieved by using non-thermally controlled (uncooled) lasers. (See FIG. 7.)

The cost difference between the packaging of DWDM lasers and CWDM lasers can be significantly reduced with a much higher yield and at a lower cost and are now both are routinely manufactured in automated facilities.

CWDM signals should be spaced approximately 20-nm apart to ensure the maximum usable bandwidth while keeping the signals from interfering with each other.

Additional Holographic Demultiplexing Issues

With respect to use of holographic demultiplexing devices for long distance WDM or DWDM transmissions as earlier described, use of a dielectric stack (serving as mirrors) can also be used to separate wavelengths by taking advantage of group velocity dispersion effects while light is propagated through the impacted holographic structure changing the propagation angle with wavelength to enable a large beam steering effect near the photonic band edge.

Laser Fiberoptic Beaming Users

Furthermore, as in transmission through single mode fiber, when propagating light simultaneously from spectrally different but equally powered laser diode sources, one needs to have a flat power spectral density across its operating bandwidth if adequate signal to noise ratios are to be maintained.

Satellite Signal to Noise Ratio Issues

The distance at which a RF wave can be detected depends on five major factors (assuming that the transmitting antennas and receiving rectennas have been well designed): the electromagnetic or noise environment of the receiver, the sensitivity of the receiver, the power of the transmitted signal, and the size of the transmitting antennas and receiving rectennas.

Additionally, every material body at a temperature above absolute zero emits electromagnetic radiation—noise—throughout the spectrum, its frequency of maximum intensity being determined by its absolute temperature.

Yet noise fundamentally limits our ability to communicate. To receive a signal, its power at the receiving rectenna shall be close but greater than that of the noise at the antenna. The noise in an amplifier comes from two sources: externally, from the antenna, and internally, generated within the amplifiers themselves where internally generated noise approaches a few degrees Kelvin.

The noise from the external environment includes the ground (for rectennas built on earth), the planetary atmosphere, the galactic background, astronomical sources of inside and outside the galaxy, and low level cosmic background radiation. All these sources, including the internal noise generated in the receiver, add up to about 15 degrees Kelvin in a system shielded to minimize the radiation from the ground. Furthermore, the distance at which an RF wave can be detected is a function of the following factors (assuming that the transmitting antennas and receiving rectennas have been well designed) namely: the electromagnetic noise environment of the receiver, the sensitivity of the receiver, the power of the transmitted signal, and the size of the transmitting antenna and receiving rectenna.

To calculate the required signal power in hertz, for example, one shall first know the noise power in the receiver, which is dependent on the frequency range, or bandwidth, of the RF receiver. Since noise is distributed across a spectrum, the narrower the receiver bandwidth, the less noise power can be admitted to the receiver. Therefore, the bandwidth is generally restricted to the smallest value that will accommodate the anticipated signal. However, the more bandwidth, the higher the rate at which one can send voice, text, video and data. A standard television signal occupies about 4.5 megahertz, for example, while a normal speech requires about 2.5 kilohertz.

For a specific bandwidth and noise temperature one can determine the signal power needed at the receiving rectenna to overcome the noise power namely (Pn) by applying the following relationship, where Pn kTB, and k is Boltzmann's constant, 1.3806×10⁻²³ joule per degree Kelvin; T is the noise temperature, 15 degree Kelvin, and B is bandwidth of the detecting antenna nearly equal to (Pn), in order to detect it in the presence of above referenced noise components. If one assumes the receiving rectenna has an effective area of one square meter, then the required intensity of the signal at the rectenna for a value of 15 degree Kelvin and B=5 hertz becomes approximately 10.4×10⁻²² watts per square meter.

Applying the inverse square relation, one can calculate the power required from a transmitter radiating omni-directionally at an estimated GEO distance from earth or approximately 5.7×10⁻¹¹ watts.

Beaming is Better

As an alternative to omni-directional RF transmission and reception, beamed laser signals offer significant advantages if one considers the trade-off between receiving rectenna size and the signal power required from the GEO beaming transmitter. When such a GEO antenna is aimed at the receiving rectenna, it has a large “gain” in the amount of power extracted from the signal or less power is needed to transmit the same signal to the receiving rectenna. The receiving laser beam however shall be aimed in a specific direction, which presents no problem for a GEO satellite of the type illustrated in FIGS. 8-18.

With minimal antenna areas the required transmitting power is higher than the corresponding beaming power requirements, yet the transmitting and receiving laser beams shall be comparatively narrow to find one another in space (as between land based or GEO antennas and LEOs).

Upgrading to an Optical Format

As demand for communications bandwidth expands, the advantages to an all optical network become apparent. One is able to replace current switches required to convert optical to electrical signals followed by the need to then convert it back again to an optical format. This sequential process is more costly and slower particularly where one has to move large quantities of data, voice and video seamlessly at high speed. Use of the micro-electromechanical systems described herein avoid this problem essentially serving as sensors, 2-D or 3-D micro-mirror switching devices capable of both sensing and manipulating light faster and with more precision than their current macroscopic equivalents.

Furthermore, CWDM is a less expensive alternative to DWDM and can take advantage of relaxed tolerances to gain greater flexibility and adaptability at lower cost as one moves toward hybrid electrical and optical networking which is particularly useful in urban (or last mile) and access networks as illustrated in FIGS. 8-18 where uncooled laser dispersion penalties are not as critical as in long distance transmissions.

Integration with Non-Optical Signals

The use of lasers for increased broadband capacity requires integration of several optical and non-optical (or hybrid) propagation strategies and flexible gateways that maximize capacity while minimizing cost per bit per mile. They also require different pathways for real time versus all other type communications, particularly if satellites as proposed are used to cover long distance transmissions to accommodate the perceived needs for an ever increasing network capacity and therefore bandwidth. DWDM and optical amplification employing optical rather than electrical elements have enabled communications systems to provide for higher bandwidth at lower cost per bit mile. Yet if future bandwidth projections are to be met at, say, 20 to 30 times today's traffic levels with a focus on cost containment for all users served, it will require implementation of the new optical and holographic technology disclosed herein to provide both greater storage and wavelength separation without degrading required dispersion, pass-band uniformity and limiting cross talk parameters.

A software-controlled computer system is used to implement a transmission path selection process to select among different transmission modes depending upon specific criteria. These criteria include speed of transmission, the needed bandwidth and the cost. The software-controlled computer system preferably detects the data rate of a particular transmission and then determines which transmission mode or system will be most cost-effective and speed appropriate. For example, if a voice call is detected, the communication is preferably routed to a low bandwidth, real-time but low cost communication system such as an ordinary telephone network. In another example, if streaming video is detected, it may be appropriate to route the data via a laser beam transmission communications system having high bandwidth and real-time speed but higher cost. Of course, each such communication system may comprise multiple types of communication protocols and modes. The computer system translates the communication signals to provide compatibility with the communications system that is selected.

Alternatively, with a multi-ransmission mode communications device, the user may actually select the mode of communication, e.g. choose among different communication systems.

Interleavers Enable for Increased Internet Traffic

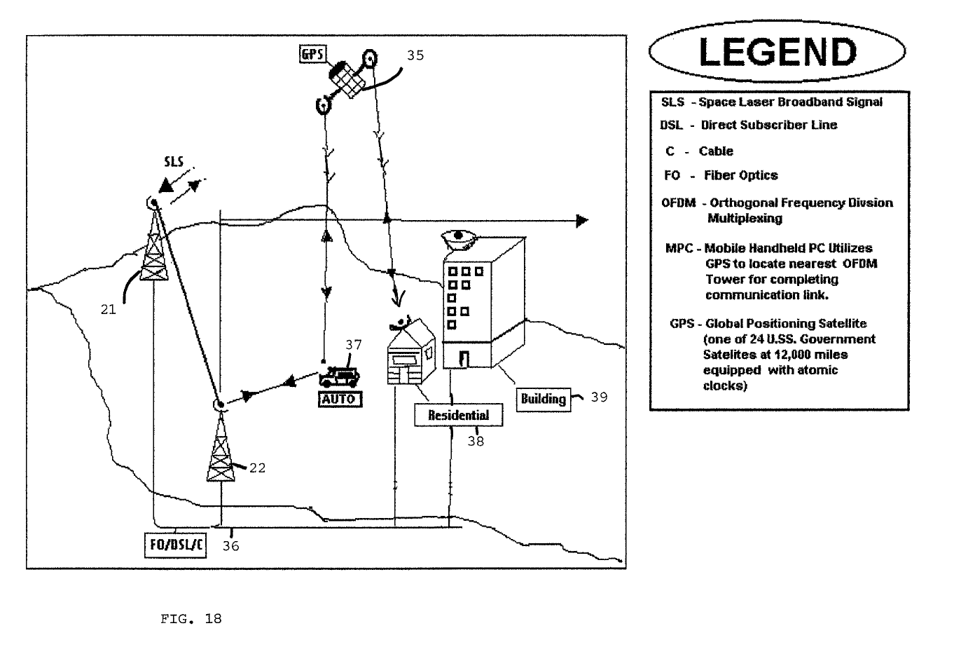

Current industry estimates suggest that Internet traffic and capacity may double every couple of years. One option is to increase the number of bits a given (i.e. existing) fiber network can carry by means of time division multiplexing, adding wavelength channels via an increased window for wavelength application or by adding more channels in the wavelengths range of the existing wavelength amplifier. With respect to the latter option, and with reference to FIG. 19, use of an Interleaver to separate an input spectrum of periodically spaced wavelengths: 1, 2, 3, 4, 5, 6, 7, 8 into two (2) sets at twice the original channel spacing; namely: 1, 3, 5, 7 and 2, 4, 6, 8. Since Interleavers can allow current generation filters to separate DWDM channels when located immediately downstream of our proposed holographic multiplexer(s) or demultiplexer(s) they can serve to create two output laser beams, each with one half of the original upstream channels and twice the original spacing. Interleavers can be further cascaded so as to reduce the number of channels and result in a increase of four times their original channels each with adequate spacing to avoid adjacent channel cross talk and potential chromatic dispersion effects yet provide a wide, effective pass-band to accommodate laser drift and to minimize the distortion of the modulated signal. Furthermore, the addition of our proposed optical Interleavers in some of the combinations described above results in major traffic increases while avoiding a higher initial installation cost (then employing conventional means, for example) while enabling growth of bandwidth capacity at a minimal future cost to accommodate above referenced projected increasing future traffic levels.

Advanced Holographic Storage Methods

One further application not previously disclosed is incorporating, the use of holographic optical write read storage into our proposed all optical network at densities approximately eighty times higher than conventional storage methods thereby providing a boon to “non-real time communications”. The latter holographic devices can store pages of information as optical interference patterns which form when two coherent laser beams intersect within a thick photosensitive material, e.g., lithium mobate, strontium barium niobate and barium titonate. Through chemical and physical changes within the latter materials, a replica of the interference pattern is stored as a change in the absorption, refractive index or thickness of the above referenced photosensitive material. Subsequent illumination with the equivalent reference beam (at same angle and wavelength) used to store a given page, for example, allows the independent readout of any desired data page and further extends the advantages of the proposed all optical holograph system referenced above.

Enhancing Mobile PDA Use

Recognizing that the principal telecommunications driver for increased broadband capacity is streaming video and data (along with voice), a communications network linked directly to the mobile PDA (Personal Digitized Assistant) is required if one is to deal with increasingly complex and changing traffic patterns in wireless phone networks. Integrating fixed point to point DWDM transmissions with the Internet Protocol format, packet switching, and use of GPS and GNSS, etc., will require advanced networks capable of assigning wavelengths and routes on a packet-by-packet basis such that optical network capacity is maximized by the dynamically allocated methods proposed herein. For example, the amount of data (or bandwidth) flowing in one direction will likely differ from that in the opposite direction. Traffic levels can also be expected to change over relatively short time periods. One way to deal with these uncertainties is to assemble an array of alternative routes in combination with holographic multiplexing, demultiplexing and storage devices and interconnected by high capacity DWDM (or other equivalent means) transmission links to RF, GPS (or GNSS) mobile users as well as fixed stations where optical layers carry out existing long distance transmissions among both fixed and mobile users and for selected local, e.g., urban or last mile users employing tunable lasers which also operate as part of the optical cross connect architecture. Such tunable lasers can change wavelength on a millisecond time scale and are capable of serving as a reconfigurable transport layer using optical cross connects that can adjust to a dynamically changing mix of local and long distance traffic patterns.

Tunable Lasers

Furthermore tunable lasers can switch wavelengths in nanoseconds across the full C-band or L-Band spectrum enabling all of the building blocks described in FIGS. 8-18, to provide the high capacity bandwidth now projected for the foreseeable future.

Advanced Hybrid PDA Configurations

The above is intended to achieve greater economies of scale and attract greater mobile user interest then merely adding conventional phone and related pager functions, etc. to handheld platforms, e.g., PDA (personal digital assistant). By turning handheld computers into phones and using them for other uses requiring high capacity and reliable broadband, a hybrid PDA according to the present invention can readily achieve increased user benefits. Such hybrids however are preferably kept small but readable, approaching when possible the size and look of today's sleek pocketable wireless phones yet with bigger displays resulting from elimination of key-pad and replaced by language activated voice commands to deal with above referenced display and data entry limitations of current commercially available wireless phones and PDA's.

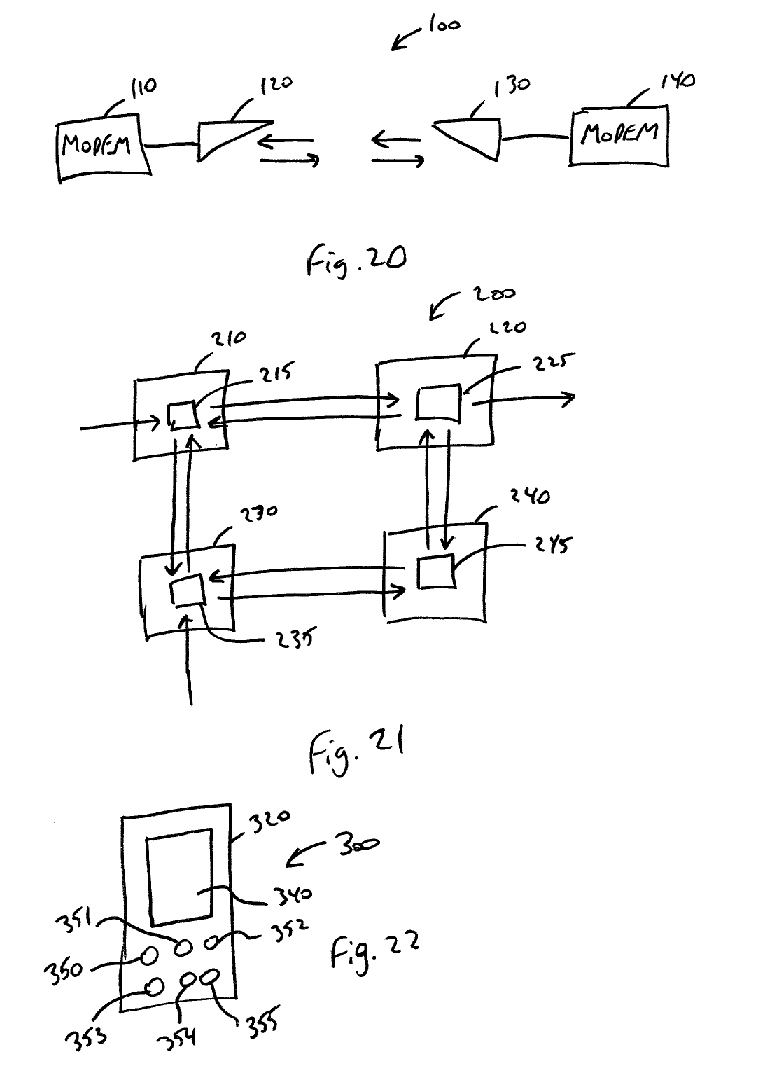

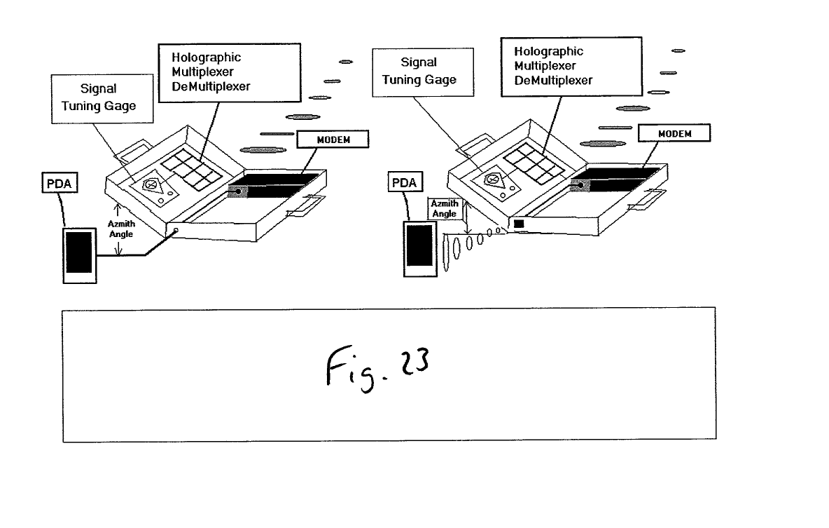

A PDA 320 according to an embodiment of the present invention is shown in FIG. 21. PDA 320 includes display 340 and buttons 350-355. Display 340 is a large crystal display. Button 350 is the on/off switch. Button 351 is the network/internet activation switch. Button 352 is the web protocol selection switch. Button 353 is the volume control. Button 354 receive activation button. Button 355 is the send activation button. As shown, no numeric keys need to be included since all other user commands are preferably voice activated. PDA may include cabling for connection to the attache case of the present invention, to a communications network (e.g., a fiber optics network) or the like.

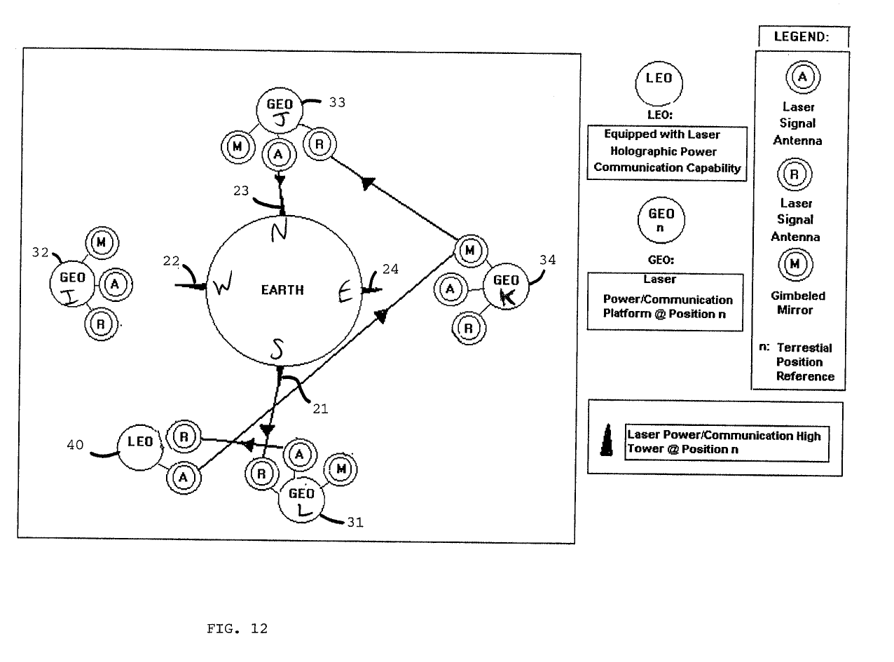

Free space optical connectivity using laser beaming is shown in FIG. 12 for establishing point-to-point bidirectional and high speed wireless telecommunications through the atmosphere. Although commercially available point-to-point laser beaming systems are available, they require an optical transceiver unit typically coupled to free space optics requiring a network interface to connect to a system with data communications infrastructure at each end. Such systems are costly and bulky, requiring heavy duty brackets and special electrical connections requiring complex electro-optical devices in weatherproof rooftop enclosures. Additionally, a sturdy temperature control system must be provided to stabilize the photonics and optics for a wide range of foreseeable environmental conditions. Such systems require rifle scope alignment and have limited scalability when customer demand for increased bandwidth is needed.

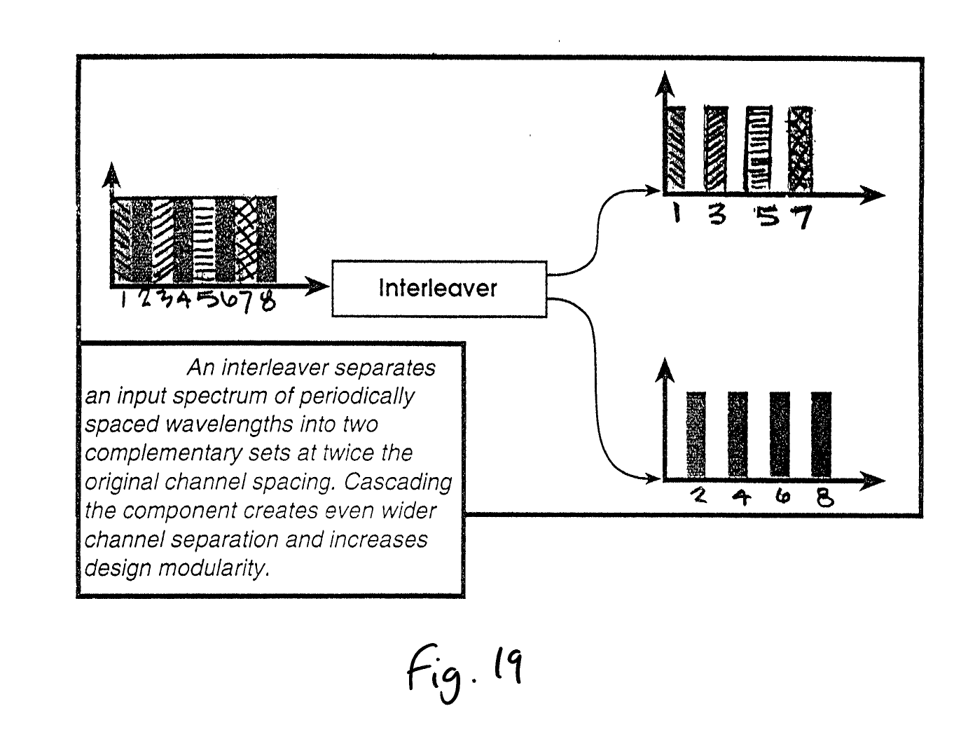

The system described herein instead utilizes an inexpensive fiber interconnected antenna/rectenna modem system 100 shown in FIG. 20 which requires no electronics to be placed outdoors and employs standard Ethernet cabling to user hub or can be fed via holographic multiplexer/demultiplexer coupling directly to an Ethernet card in a user's PC. System 100 comprises modems 110 and 140 and holographic multiplexer/demultiplexers 120 and 130.

In FIG. 21, an optical interface system 200 for buildings in a local area network is shown. In system 200, each building 210, 220, 230 and 240 includes a holographic multiplexer/demultiplexer 215, 225, 235 and 245, respectively. Preferably, each building both receives for delivery to designated building users and resends to other buildings using add/drop devices programmed by web software employing existing protocols to accompany embedded information and/or data (voice and graphics).

A holographic communication network can be thought of as a fourth generation technology in the ongoing digital evaluation of internet usage aimed at the mobile user, enabling fixed and mobile users alike to talk directly with each other using existing protocols and those to be developed in the future. By relying upon web service protocols, e.g., SOAP (simple object access protocol), UDDI (universal description, discovery and integration ), or WSDL (web services description language), that are already in widespread use and capable of incorporation via modem, various applications and information uses can be identified for predetermined uses without interfering with other voice, data, video streaming data directed through mobile-tomobile, mobile-to-fixed, or fixed-to-mobile channels. Through the initiation of appropriate PDA or PC commands, enabling modular software can separate such “tagged” data streams for differentiated use as directed by the initiating user.

A number of embodiments of the present invention have been described above. Nevertheless, it will be understood that various modifications may be made without departing from the spirit and scope of the invention. Accordingly, other embodiments are within the scope of the following claims. It is intended that all matter contained in the above description or shown in the accompanying drawings shall be interpreted as illustrative and not in a limiting sense.

What is claimed is:

1. A communications system comprising:
a first holographic communications server;
a first holographic multiplexer/demultiplexer, coupled to said first holographic communications server;
a second holographic communications server; and
a second holographic multiplexer/demultiplexer, coupled to said second holographic communications server; and
wherein the first and second multiplexer/demultiplexers are coupled by an optical communications link.

2. The system according to claim 1 further comprising a plurality of mobile communications devices coupled to said second holographic communications server.

3. The system according to claim 1 further comprising a plurality of fixed communications devices coupled to said second holographic communications server.

4. The system according to claim 1 further comprising:
a radio frequency communications device coupled to said second holographic communications server; and
a plurality of mobile communications devices coupled to said radio frequency communications device.

5. The system according to claim 1 further comprising a radio frequency communications server coupled to said second holographic communications server.

6. The system according to claim 5 wherein said radio frequency communications server comprises a radio transmitter and an antenna.

7. The system according to claim 1 further comprising a satellite communications server coupled to said second holographic communications server.

8. The system according to claim 1 further comprising a fiber optic communications server coupled to said second holographic communications server.

8. The system according to claim 1 further comprising a fiber optic communications server coupled to said second holographic communications server.

9. The system according to claim 1 further comprising a terrestrial communications server coupled to said second holographic communications server.

10. The system according to claim 1 further comprising a global positioning satellite (GPS) communications device coupled to said second holographic communications server.

11. The system according to claim 1 further comprising a computer system for coupled to said second holographic communications server.

12. The system according to claim 11 wherein said computer system detects a data rate of a communications signal and routes said communications signal to one of a plurality of communications systems based upon said data rate.

13. The system according to claim 12 wherein said computer system translates a protocol of said communications signal to correspond to a protocol of the communications system to which said communications signal is routed.

14. A space to space, land to land and space to land long distance communications system comprising:
spaced based receiving and transmitting means for receiving and transmitting a communication signal; and
land based receiving and transmitting means for receiving and transmitting said communication signal;
wherein said spaced based receiving and transmitting means communicates with said land based receiving and transmitting means by wireless laser beams utilizing a holographic multiplexer and a holographic demultiplexer.

15. An mobile communications apparatus comprising:
a transmitter/receiver, and
at least one of a holographic multiplexer and a holographic demultiplexer, coupled to said transmitter/receiver.

16. The apparatus of claim 15 further comprising a power source coupled to said transmitter/receiver.

17. The apparatus of claim 16 wherein said power source comprises a solar panel.

18. A communications system comprising:
a holographic multiplexer;
a holographic demultiplexer; and
an optical interleaver located downstream of one of said holographic multiplexer and said holographic demultiplexer for separating laser beam wavelengths.
